(19) United States
(12) Patent Application Publication
(10) Pub. No.: US 2002/0185367 A1
(43) Pub. Date: Dec. 12, 2002

(54) Recycling device of the material to be processed

(76) Inventor: Akira Akazawa, Osaka (JP)

Correspondence Address: MOONRAY KOJIMA, BOX 627, WILLIAMSTOWN, MA, 01267, US

(21) Appl. No.: 09/878,687

(22) Filed: Jun. 11, 2001

(51) Int. Cl. B01D 3/00

(52) U.S. Cl. 202/185.3; 159/16.1; 202/201; 202/203; 203/42; 203/49

(57) ABSTRACT

The air B supplied from the air-sending device 23, constructing the recycling device 1 of the material to be processed, is kept in contact with the coolant A absorbed into or attached to the belt 4 for being dipped into liquid, wherein the air B inspired by the discharging device 49 is kept in contact with the coolant A dripping down or passing the plate 42 on which liquid flows down so that water from the coolant A will be evaporated when drying natural, thus increasing the density of ethylene glycol. The coolant A condensed to a given density is dripped down from the belt 4 for being dipped into liquid and the plate 42 on which liquid flows down so that, upon being reserved in the liquid recovering container 3 or the liquid reserving container 43, the coolant A, which is already recycled, is recovered from the container 3, 43.

### BACKGROUND OF THE INVENTION

1. Field of the Invention

The present invention relates to the recycling device of the material to be processed, used to separate water from waste liquid such as coolant used as a cooling agent for the metal process or the radiator of the automobiles, for example, or the material to be processed like the dirty objects such as excrements and feces and urine from the animals.

2. Description of the Prior Art

Conventionally, as the coolant to be used for the above described radiator is diluted to a given density with water and distilled water, for the recycling of the used coolant, the coolant may be heated by the heater so that water is distilled from the coolant, thus elevating the density of ethylene glycol liquid as a main component. However, in order to distill water contained in the coolant, there must be a large quantity of electricity and fuel so that the recycling cost is high, involving more expenses than buying a coolant that has not been used.

In addition, the warm air supplied from the warm wind-generating machine dries the slurry attached to the plane surface of the belt (Gazette of Patent Publication Showa 52-32165) upon blowing the said air against the slurry, involving a large amount of heat in order to evaporate water contained in the slurry, costing much. Furthermore, the dimension to be blown against by warm air at once is restricted, taking a lot of time to be dried. When the belt is formed to be long and large enough to evaporate water, the machine becomes large and has a problem that a huge space for installation will be needed.

### SUMMARY OF THE INVENTION

The main purpose of the present invention is to provide for drying natural the material to be processed, without using electricity or fuels, thus, effectively carrying out the recycling (condensing) the material to be processed into a certain state while improving the recycling efficiency and reducing the recycling cost, wherein the air is brought in contact with the material to be processed, attached to the object with the material to be processed so that water contained in the material to be processed will be separated by means of absorbing effects of the air.

Another purpose of the present invention is to allow for separating water efficiently in a short period of time by having a large contact dimension of the material to be processed with the air, wherein the air is brought into contact with the material to be processed, attached to the layer part of the object with the material to be processed. Furthermore, the dimension and time necessary for the recycling can be secured in a small space, thus making the machine smaller.

Furthermore, another purpose of the present invention is to provide for separating efficiently and actively water contained in the material to be processed, by bringing the new air supplied from the air-supplying means in contact with the material to be processed, attached onto the object with the material to be processed in a consecutive manner.

Furthermore, another purpose of the present invention is to provide for separating efficiently water contained in the material to be processed, wherein the air heated by the air-heating means is more dry and with less water than the air with an ordinary temperature.

Alternatively, another purpose of the present invention is to recycle water in a short period of time as water contained in the material to be processed is easy to evaporate, wherein the material to be processed, which has been heated by the heating means of the material to be processed, is brought in contact with the air.

In addition, another purpose of the present invention is to surely carrying out the operation of recycling the material to be processed while improving the recycling efficiency, wherein the material to be processed, of which water is separated by a liquid-separating recycling means, is separated from the object with the material to be processed.

Furthermore, other purposes of the present invention will be easily clarified according to the below-described examples.

### BRIEF DESCRIPTION OF THE DRAWING

FIG. 1 shows a side view of the recycling process by the liquid-recycling means according to the example 1.

FIG. 2 shows a side view of the recycling process by the liquid-recycling means according to the example 2.

FIG. 3 shows a side view of the recycling process by the liquid-recycling means according to the example 3.

FIG. 4 shows a side view of the recycling process by the liquid-recycling means according to the example 4.

### DESCRIPTION OF THE PREFERRED EMBODIMENT

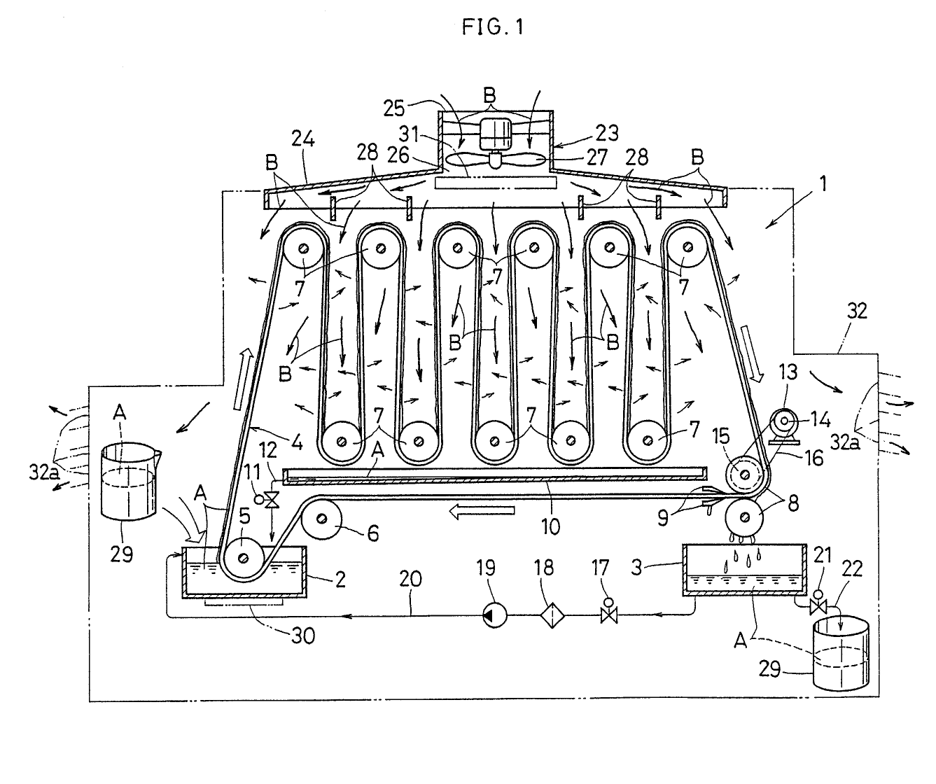

The figures show the liquid recycling machine according to the example 1, comprising the step of separating water from the used coolant, which is one example of the material to be processed, for recycling while condensing the material to a given density, wherein, according to the FIG. 1, the liquid recycling machine 1 of the present invention is provided with the liquid reserving container 2 for containing an old coolant A mainly composed of ethylene glycol taken away from the automobile's radiator, the liquid recycling container 3 for containing the coolant A condensed to a certain density and the belt 4 having adhesive liquids, extended between the upper part of the liquid reserving container 2 and the liquid recycling container 3, all together inside the processing cell 32, shown with the virtual lines in the figures.

The belt 4 having adhesive liquids as described above, comprises the simple materials like chemical fibers or natural fibers or the towel stuffs, which are porous or penetrative, being made of the complex materials. Alternatively, instead of the towel stuffs, there may be used, for example, a filter in the shape of a belt, a net, sheets, non-woven cloth, fibers or a belt provided with porous and absorbing materials, a belt with layers of absorbing materials in the form of cottons between non-woven cloths and synthetic rubber products, which are flexible and porous or metal belts and so on.

In addition, one end side of the belt 4 to be dipped into liquid is provided with the immersing roller 5 installed at the height of being dipped into the coolant A contained in the liquid reserving container 2 and the supporting roller 6 on the returning side of the liquid reserving container 2.

The intermediate (zigzagging) part is provided between the upper part of the liquid reserving container 2 and the upper part of the liquid recycling container 3 with the supporting rollers 7, both above and below, zigzagging up and down (or horizontally), with the end part provided with a pair of the pressing rollers 8, above and below, installed on the upper side of the liquid recycling container 3.

The above-described pressing roller 8 is formed beyond the sending length of the belt 4 for being dipped into the liquid and set resilient in the same direction as the belt 4 for being dipped into the liquid, the same belt being pressed by the resilient means like spring or weight. In addition, the pressing force or the space of the pressing roller 8 may vary according to the thickness of the belt 4 for being dipped into the liquid or the viscosity of the coolant A.

Additionally, a pair of the scrapers 9 are provided right after the pressing roller 8, facing the sending direction of the belt 4 for being dipped into the liquid on its above and below side.

The liquid receiving part 10 provided under the zigzagging part of the belt 4 for being dipped into the water as described above, receives the coolant A dripped from the belt 4 for being dipped into the liquid, the same coolant A returning to the liquid reserving container 2 through the valve 11 and the returning route 12.

The motor 13 with a reduction gear, provided on the end side of the machine, by means of the sprockets 14, 15 and the chain 16 rotates the immersing roller 5, the supporting roller 6, 7 and the pressing roller 8 by moving or associating them, thus rotating the belt 4 for being dipped into the liquid in its sending direction. Alternatively, the handle (not shown in the figures) connected to a determined roller, may be manually operated, thus rotating manually the belt 4 for being dipped into the liquid.

The coolant A contained in or dripped from the liquid recycling container as described above, returns to the liquid reserving container 2 through the valve 17, filter 18, pump 19 and the returning route 20. Alternatively, the coolant A may be discharged or recycle through the valve 21 and the recycling route 22.

The ventilating device 23 provided on the upper part or on the side of the above-described processing cell 32 opens up the inspiring outlet 25 provided on the upper side of the duct 24 toward the outside air, thus opening the discharging outlet 26 provided on the below side of the said duct, while making this roughly as large as the above side of the zigzagging part of the belt 4 for being dipped into the liquid.

The fan 27 provided inside the above said duct 24 discharges the air B (gas) inspired from the inspiring outlet 25 through the filter (not shown in the figures), from the discharging outlet 26. The dispersing plates 28 installed on the below edge of the discharging side, disperse the air B roughly evenly toward all areas of the zigzagging part of the belt 4 for being dipped into the liquid. Thus, the air B supplied into the cell will be discharged from the discharging outlet 32 a provided on the side wall of the processing cell 32.

As other air-supplying means for the above ventilating machine 23, there may be used a ventilating blower or a fan and compressors. Additionally, instead of the air B, gas or air with less effect on the natural environment may, for example, be used.

Alternatively, in order to elevate the condensing efficiency of the coolant A, the coolant A may, for example, be heated by the heater 30 shown with the virtual line in the figures, which heater is attached to the bottom of the liquid reserving container 2 (or the supporting roller 7) to a certain temperature (at which water evaporates, for example), or alternatively the air B may be heated by the heater 31 shown with the virtual line in the figures, which heater is installed at the discharging outlet 26 of the duct 24. Alternatively, they may be rid of humidity by the device for getting rid of humidity (not shown in the figure).

The examples shown in the figures are constructed as above, and there will be below explained the method of separating water from the coolant A by the liquid recycling device 1 and recycling after condensing to a certain density.

First of all, as shown in the FIG. 1, the processing cell will be opened, wherein an old coolant A having density or less density than roughly 20% to roughly 50% of liquid, contained in the container 29 may be poured into the liquid reserving container 2 and the said coolant A may be adhered or absorbed by the belt for being dipped into liquid, which belt is rotating at a certain speed.

Furthermore, the air B supplied from the ventilating device 23 is brought into contact with the coolant A attached to the belt 4 for being dipped into liquid, roughly evenly from above, in order to separate water contained in the coolant A with the air B absorbing or evaporating so that the ethylene glycol liquid may be elevated to a certain density of roughly 80%. The air B having absorbed water may be discharged out of the processing cell 32. Alternatively, water may be separated from the coolant A by using the natural wind.

At the same time, the coolant A of high density, attached to the belt 4 for being dipped into liquid will be forcibly pressed out by a pair of pressing rollers 8, above and below so that the coolant A will be scraped by both scrapers 9, above and below, thus getting dripped into the liquid recycling container 3.

The following steps involve the continuous rotation of the belt 4 for being dipped into liquid and the recycling process of separating water from the coolant A continuously. Alternatively, the coolant A may be brought back from the liquid recycling container 3 to the liquid reserving container 2, carrying out the same steps repeatedly.

In the following step, the coolant A already recycled may be recovered from the cell after opening the valve 21 and reserving for a while in the container 29, thus improving the recovering efficiency and economical merits.

In addition, from outside the cell there may be supplied or recovered the coolant A. On the other hand, the coolant A already recovered may be recycled by the coolant recycling device (not shown in the figures), which uses the ion-exchanging film, for example.

In addition, the condensing efficiency of the coolant A varies depending on the volume of the air sent or temperature and so on and the condensing efficiency may variably be adjusted by increasing or decreasing the rotating speed of the belt 4 for being dipped in liquid, for example, or changing the number of zigzagging steps or length.

Furthermore, another method of heating, instead of using the heating device 30, 31, includes the heat-exchanging device (to be used outside the cell) attached to the air-conditioning machine or the heating of the coolant A or air B by utilizing the heat emitted from the factories or the heating may be carried out by irradiating the sun or lamps, for example.

As described above, the air B is brought into contact with the coolant A attached to the belt 4 for being dipped into liquid so that water contained in the coolant A will be evaporated and separated, thus allowing for drying natural without using electricity or fuels and as a result, the coolant A will be recycled (condensed) to a certain drying state while improving the recovering efficiency or effectuating the reduction of the recycling cost.

Furthermore, the air B supplied from the air-sending machine 23 is brought into continuous contact with the coolant A attached onto the zigzagging part of the belt 4 for being dipped into liquid so that the dimension of contact of the coolant A with the air B becomes large, thus allowing for efficient separation of water in a short period of time. Alternatively, the dimension and time necessary for the recycle can be secured in a small space, thus allowing for making the machine small and separating water contained in the coolant A efficiently and largely.

Alternatively, the coolant A heated by the heater 30 may be brought into contact with the air A so that water contained in the coolant A may be easily evaporated and can be recycled in a short period of time. Alternatively, when the air B is heated by the heater 31, less water may be dried than the air B with an ordinary temperature so that water from the coolant A may be effectively separated, allowing for effectively carrying out the step of drying with mutually increasing effects.

Additionally, as the coolant A already condensed by the pressing roller 8 or the scraper 9 is forcibly separated from the belt 4 for being dipped into liquid, the secure operation of recovering the recycled liquid can be obtained, thus improving the recovering efficiency.

In addition, the influences from outside temperature or humidity are so little that the secure separation and condensation of liquid can be done. Additionally, the belt 4 for being dipped into liquid may be oriented to get exposed to outside air while being recycled as described above. When many liquid recycling devices 1 are installed, the volume of water in the air increases, it is also possible to increase the occurrence of humidity, shower or dews, for example, in the surrounding environment.

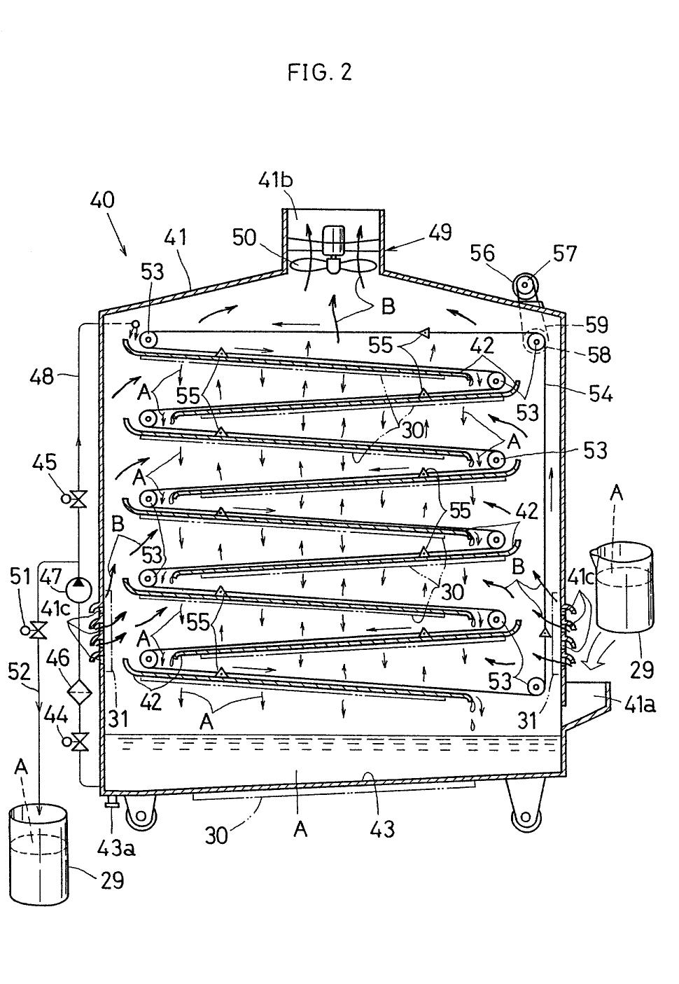

The FIG. 2 shows the liquid recycling device 40 according to the example 2, wherein, inside the processing cell 41, there may be installed vertically the plates 42 on which liquid flows, which plates are unevenly paralleled, being formed of materials such as metal or plastic, for example, while being inclined with such an angle to make the coolant A flow down in an unevenly parallel way.

Furthermore, there are formed a plurality of holes in a given distance, one from another, capable of letting liquid pass, for example, in the points on which water drops, of the plate 42 where liquid flows down. Alternatively, the plate 42 where liquid flows down may be provided with filters or non-woven cloth, stuff and sheets, those capable of passing air or getting penetrated.

The liquid reserving container 43 installed at the bottom of the processing cell 41 as described above will be supplied with the old coolant A reserved in the container 29 through the supplying outlet 41 a, which is provided on the bottom side wall of the processing cell 4. The coolant A reserved in the liquid reserving container 43 will be supplied onto the plate 42 of the highest level, on which liquid flows down through the valve 44, 45, the filter 46, the pump 47 and the supplying route 48.

When separating water from the coolant A by the above-mentioned device, the fan 50 of the discharging device 49 installed on the discharging outlet 41b on the above side of the processing cell 41 is driven and the air B inspired from the inspiring hole 41c formed on the side of the processing cell 41 will be kept in contact with coolant A flowing down or passing the plate 42 on which liquid flows down, thus evaporating and separating water from the coolant A and dripping the liquid of ethylene glycol into the liquid reserving container 43 while elevating its density.

In addition, before the air B containing water is discharged into air, very little of the coolant A, contained in water inside the air B, may be condensed and separated for recovery.

The coolant A as described above, may be heated by the heater 30 shown with the virtual line in the figures attached to the plate 42 on which liquid flows down or the liquid reserving container 43 (or the supplying route 48) or the air B may be heated by the heater 31 shown with the virtual line in the figures, attached on the inspiring hole 41 c, as the effects of increasing efficiency in condensing the coolant A can be obtained as in the example 1 described above.

On the other hand, after the above recycling steps are repeated several times, the density of ethylene glycol is elevated and as the valve 45 is closed and the valve 51 is opened, the coolant A already recycled, which is discharged from the recovering route 52 connected to the supplying route 48 is recovered into the container 29, thus carrying out operational effects in the roughly same manner or more successfully than the above-mentioned example 1. Also, at the bottom of the liquid reserving container 43, there is provided the drain route 43a.

As a method of helping the above-mentioned coolant A flow down, the endless band 54 of the plastic (or metal or rubber) make is extended both on the upper end part of the plate 42 . . . on which liquid flows down and the pulley 53 . . . installed by the inner wall part of the processing cell 41, and the endless bands 54 are rotated in the sending direction through the sprocket 57, 58 and the chain 59 by the driving forces of the motor 56 with the reduction gear, installed on the upper side of the processing cell 41, wherein the scrapers 55 roughly in the shape of a triangle seen from the side, which scraper is installed between the endless bands 54 are moved along the plates 42 on which liquid flows down and the coolant A absorbed or attached to the plate 42 on which liquid flows down may be forcibly dripped down.

Additionally, instead of using the scraper 55 in the shape of a triangle, the scrapers with a roller shape or plate shapes may be used and as another means of dripping down than the scrapers 55, the vibrations induced by the vibration generating machine (not shown in the figures), for example may be given to the plate 42 on which liquid flows down, thus promoting the dripping down or passage of the coolant A.

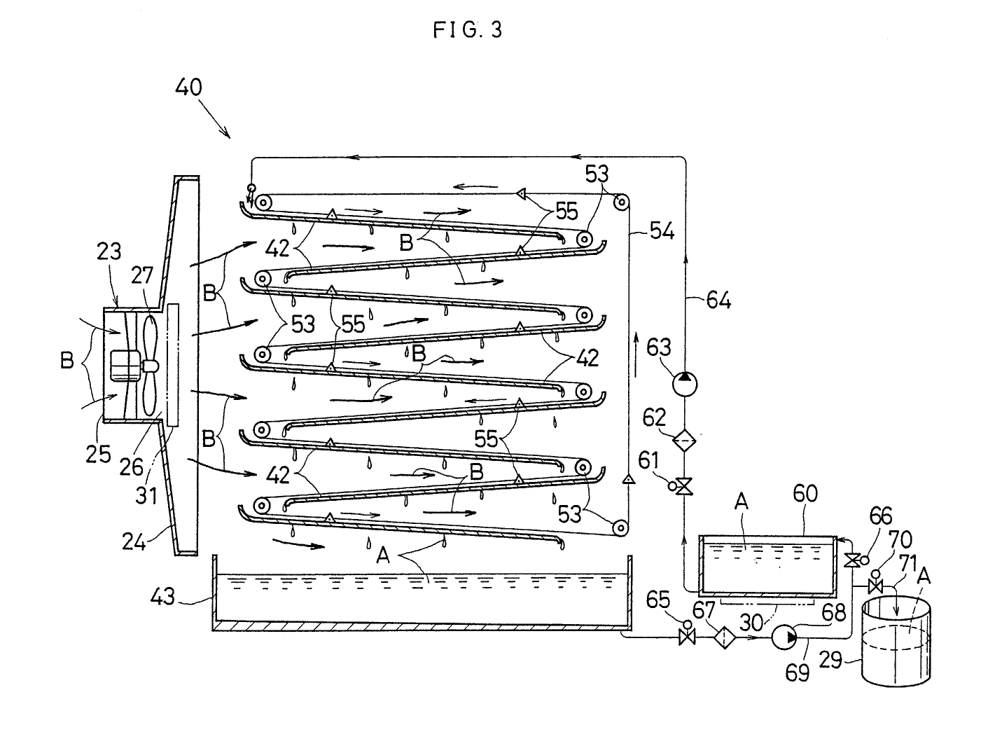

The FIG. 3 shows the liquid recycling device 40 according to the example 3, wherein the air B (or natural wind) supplied from the air-sending machine 23 or environmental air may be kept in contact with the coolant A passing or dripping down on the plates 42 on which liquid flows down, which plates are exposed to the outside air, thus evaporating water from the coolant A and discharging it to outside air, while elevating the density of the liquid of ethylene glycol.

On the other hand, the coolant A already used is once reserved in the liquid reserving container 60, the coolant A will be supplied onto the plates 42 on which liquid flows down, of the highest level, through the valve 61, the filter 62, the pump 63 and the supplying route 64. The coolant A reserved in the above-mentioned liquid reserving container 43 may be condensed to a certain density by returning to the liquid reserving container 60 (or getting supplied to the plate 42 on which liquid flows down, of the highest level), through the valve 65, the filter 66, the pump 67 and the returning route 69, while repeating the above said recycling process. On the other hand, as the coolant A already recycled, discharged from the recovering route 71 connected with the returning route 69 is to be recovered into the container 29 by opening the valve 70, operational effects will be expected roughly in the same manner as or more successfully than the above-mentioned examples 1 and 2.

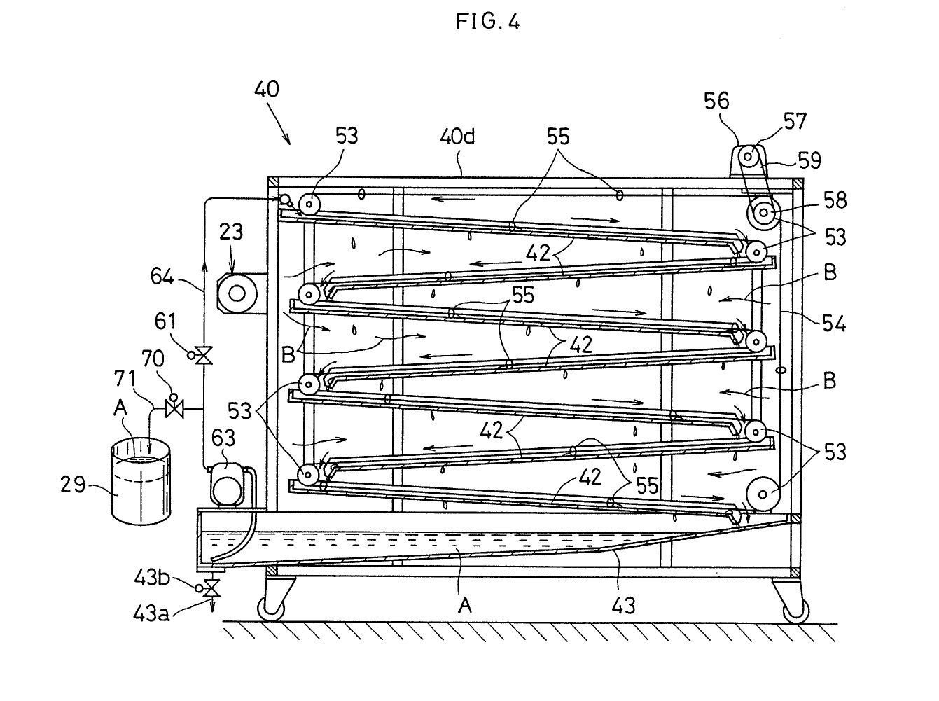

The FIG. 4 shows the liquid recycling device 40 in the example 4, wherein the plate 42 . . . on which liquid flows down, is installed to get exposed to outside air with the system body 40 d, which is so set as to move running, while the air B supplied from the air or the air sending machine 23 is kept in contact with the coolant A flowing down or passing the plate 42 on which liquid flows down, to evaporate water while elevating the density of ethylene glycol, thus carrying out operational effects roughly in the same manner as or more successfully than the above-mentioned example 3.

On the other hand, the coolant A reserved in the liquid reserving container 43 will be supplied onto the plate 42 on which liquid flows down, of the highest level, through the valve 61, the pump 63 and the supplying route 64. Additionally, at the bottom of the liquid reserving container 43, there is provided the drain route 43 a through the valve 43b.

In the above described example 4, the same numbers are put for the same constructions as in the above-mentioned examples 2 and 3 and more detailed explanation will be omitted.

In relation with the construction of the present invention and the above-mentioned examples, the material to be processed and the object of the present invention corresponds to the coolant A in the examples, thus the recycling device of the material to be processed, corresponding to the liquid recycling devices 1, 40, the object with the material to be processed, corresponding to the belt 4 to which liquid is attached and the plate 42 on which liquid flows down, the means for supplying the material to be processed, corresponding to the liquid reserving container 2, 43, 60, the valve 44, 45, 61, the filter 46, 62, the pump 47, 63 and the supplying route 48, 64, the means for recovering the material, corresponding to the liquid recovering container 3, the valves 21, 51, 65, 66, 70, the recovering container 22, 52, 68, 71, the filter 67 and the returning route 69, wherein the means for supplying the air, corresponds to the air-sending machine 23 and the discharging device 49, the air-heating means corresponding to the heater 31, the heater of the material to be processed, corresponding to the heater 30, the separating means for the material, corresponding to the pressing roller 8, the scraper 9, 55. However, the scope of the present invention shall not be limited to the construction of the above described examples.

The construction of the above liquid recycling device 1, 40 can also be applied to the operation of separating water from the dirty objects such as feces or excrements of animals, for instance.

1. The recycling device of the material to be processed for recycling the said material to be processed to a given state by separating water contained in the material to be processed, wherein the object with the material to be processed, on which the said material to be processed is attached, is kept in possible contact with the air for absorbing the said water, being provided with the means for supplying the material for attaching the said material to be processed to the object with the material to be processed and the means for recovering the material, from which water is separated from the said object with the material to be processed.

2. The recycling device of the material to be processed according to the claim 1, wherein the said object with the material to be processed is provided with layers, each in such a distance from another as to permit the passage of the said air.

3. The recycling device of the material to be processed according to the claim 1, provided with the means for supplying the air to keep the said air in contact with the material to be processed, attached to the said object with the material to be processed.

4. The recycling device of the material to be processed according to the claim 1, provided with the means for heating the air to heat the said air to so suitable a temperature as to separate water contained in the said material to be processed.

5. The recycling device of the material to be processed according to the claim 1, provided with the means for heating the material to be processed, for heating the said material to be processed, to so suitable a temperature as to separate water contained in the said material to be processed.

6. The recycling device of the material to be processed according to the claim 1, provided with the means for separating the material from the said object with the material to be processed.
